(19) United States
(12) Patent Application Publication
(10) Pub. No.: US 2026/0322199 A1
(43) Pub. Date: Oct. 15, 2026

(54) STACKED PRINTED CIRCUIT BOARD STATOR

(71) Applicant: LITENS AUTOMOTIVE PARTNERSHIP, Woodbridge (CA)

(72) Inventor: Matthew VIOLA, WOODBRIDGE (CA)

(21) Appl. No.: 19/483,695

(22) PCT Filed: Jun. 14, 2024
(86) PCT No.: PCT/CA2024/050812

§ 371 Date: Nov. 12, 2025

Related U.S. Application Data
(60) Provisional application No. 63/508,801, filed on Jun. 16, 2023.

(51) Int. Cl. H02K 3/26; H02K 3/28

(52) U.S. Cl. CPC H02K 3/26; H02K 3/28; H02K 2203/03

(57) ABSTRACT

A stator for an electrical motor includes first and second multiple-foil layer PCB stators that are laminated together and electrically connected in a serial manner. Each PCB stator includes a circumferentially distributed sequence of radially orientated spokes, each spoke being formed from overlapping radially orientated traces in the foil layers, wherein the overlapping traces are interconnected via at least two straight vias at opposing ends of the radially orientated traces, wherein the spokes are connected in a basic coil winding pattern to form first and second sets of one or more phase winding segments. The first and second PCB stators are laminated together and a series of straight vias extend through the first and second PCB stators to provision input/output terminals and to serially connect the first set of phase winding segments to corresponding phases of the second set of phase winding segments.

### CROSS-REFERENCE TO RELATED APPLICATION

This application claims priority and the benefit of U.S. provisional patent application No. 63/508,801 filed on Jun. 16, 2023, the entire contents of which are incorporated by reference in this application, where permitted.

### FIELD OF THE DISCLOSURE

The disclosure generally relates to the field of electrical machines, and more particularly to the field of electric machines that utilize a printed circuit board as a stator element.

### BACKGROUND OF THE DISCLOSURE

It is known to use a printed circuit board (PCB) to contain the windings that form the stator of an electric machine. One issue that arises in the use of PCB stators relates to electrical efficiency. The magnetomotive (mmf) force generated in the stator is proportional to the amp-turns; i.e., for a given phase winding, a higher applied current and/or a greater number of turns can generate a comparatively higher mmf. Conversely, efficiency and generated waste heat is proportional to I²R, where I is the electric current flow through the windings and R is the resistance of the windings. In a PCB stator, the resistance of the windings is complicated by, and very much dependent on, the shapes of the PCB traces and the manner in which they are interconnected, particularly between PCB layers. It would be desirable to develop a multi-layer PCB stator that contends with these contradictory factors and which can be utilized in a wide variety of applications whilst yielding decent efficiency and cost-effective construction.

### SUMMARY OF THE DISCLOSURE

In a first aspect, a stator (e.g., for an electrical motor) is provided. Broadly speaking, the stator includes first and second PCB stators comprising a plurality of first conductive layers and a plurality of second conductive layers, respectively, and that are laminated together and electrically connected in a serial manner.

The first PCB stator includes a circumferentially distributed sequence of radially-orientated first spokes, each first spoke being formed from overlapping radially orientated first traces in the first foil layers, wherein the overlapping traces are interconnected via at least two first straight vias at opposing ends of the radially orientated first traces, wherein the first spokes are connected in a basic coil winding pattern to form a first set of one or more phase winding segments. Likewise, the second PCB stator includes a circumferentially distributed sequence of radially-orientated second spokes, each second spoke being formed from overlapping radially orientated second traces in the second foil layers, wherein the overlapping second traces are interconnected via at least two straight second vias at opposing ends of the radially orientated second traces, wherein the second spokes are connected in said basic coil winding pattern to form a second set of one or more phase winding segments. The first and second PCB stators are laminated together and a series of straight vias extend through the first and second PCB stators to provision input/output terminals and to serially connect the first set of phase winding segments to corresponding phases of the second set of phase winding segments.

The basic coil winding pattern can include a first coil formed of a first set of n sequential spokes of the first spokes connected through first inner and outer circumferential traces to a second set of n-1 sequential spokes of the first spokes disposed at a pole edge to edge circumferential distance from the first set of n sequential spokes such that the first coil is wound in a first winding direction, coupled to a second adjacent coil formed of a third set of n sequential spokes of the first spokes connected through inner and outer circumferential traces to a fourth set of n-1 sequential spokes of the first spokes disposed at the pole edge to edge circumferential distance from the third set of n spokes such that the second coil is wound in a second winding direction, opposite the first winding direction.

The stator may have three electrical phases that are connected together at a common point to provision a ‘Y’ connection.

In some embodiments, the plurality of first conductive layers may be a plurality of first foil layers and the plurality of second conductive layers may be a plurality of second foil layers.

More generally, the stator can be generalized to provide more than one serial connection per phase. According to this aspect, a stacked PCB stator is provided that includes a plurality, NB, of PCB stators each comprising a plurality, NF, of foil layers, each of the NB PCB stators including a circumferentially distributed sequence of NS radially-orientated spokes, each spoke being formed from overlapping radially orientated traces in the foil layers, wherein the overlapping traces are interconnected via at least two straight vias at opposing ends of the radially orientated traces, and wherein the NS spokes are connected in a basic coil winding pattern to form NB sets of NP phase winding segments. Here,
NB>1,
NP is a number of electrical phases,
NF=2*NP, NF being the number of foil layers of each PCB stator, and
NS=NSP*PPP*NP, subject to the constraints that NSP is an odd number>1 and PPP is an even number, where NSP is a number of spokes per pole, and PPP is a number of poles per phase

The NB PCB stators are laminated together and a series of NV straight vias that extend through the assembled NB PCB stators to provision input/output terminals and to serially connect corresponding phases of the NB sets of phase winding segments, where NV=NP*NB.

For the stacked PCB stator, the basic coil winding pattern can include a first coil formed of a first set of n sequential spokes of the spokes connected through first inner and outer circumferential traces to a second set of n-1 sequential spokes of the spokes disposed at a pole edge to edge circumferential distance from the first set of n sequential spokes such that the first coil is wound in a first winding direction, coupled to a second adjacent coil formed of a third set of n sequential spokes of the spokes connected through inner and outer circumferential traces to a fourth set of n-1 sequential spokes of the spokes disposed at the pole edge to edge circumferential distance from the third set of n spokes such that the second coil is wound in a second winding direction, opposite the first winding direction.

The stacked PCB stator may have three electrical phases that are connected together at a common point to provision a ‘Y’ connection.

In some embodiments, the plurality of first conductive layers may be a plurality of first foil layers and the plurality of second conductive layers may be a plurality of second foil layers.

### BRIEF DESCRIPTION OF THE DRAWINGS

The foregoing and other aspects of the invention will now be described in greater detail, by way of example only, with reference to the attached drawings, in which like reference characters denote like parts and in which:

FIG. 1 is a schematic diagram of an embodiment of a first basic coil winding pattern;

FIG. 2 is a schematic diagram of an embodiment of a second basic coil winding pattern;

FIG. 3 is a plan view of an embodiment a first PCB stator;

FIGS. 4A-4F are plan views of embodiments of individual first, second, third, fourth, fifth and sixth copper foil layers, respectively of the PCB stator shown in FIG. 3;

FIG. 5 is a plan view of an embodiment of a second PCB stator;

FIGS. 6A-6F are plan views of individual first, second, third, fourth, fifth and sixth copper foil layers, respectively, of the PCB stator shown in FIG. 5;

FIG. 7 is a circuit diagram of an embodiment of a first stacked PCB stator, wherein the first and second PCB stators of FIGS. 3 and 5, respectively, are stacked together and connected electrically in a serial manner;

FIG. 8 is a schematic cross-sectional-like representation, not precise or to scale, of the embodiment of the first stacked PCB stator of FIG. 7 illustrating terminal vias for provisioning input/output (I/O) terminals and serially connecting the first and second PCB stators;

FIG. 9 is a circuit diagram of an embodiment of another stacked PCB stator which employs three PCB stators stacked together and connected electrically in a serial manner; and

FIG. 10 is a schematic cross-sectional-like representation, not precise or to scale, of the embodiment of the second stacked PCB stator of FIG. 9 illustrating terminal vias for provisioning input/output (I/O) terminals and serially connecting the three PCB stators.

### DETAILED DESCRIPTION OF EXAMPLE EMBODIMENTS

### Interpretation

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise explained, all technical and scientific terms used herein have the same meaning as commonly understood by one of ordinary skill in the art to which this disclosure belongs.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

The indefinite article “a” is not intended to be limited to mean “one” of an element. It is intended to mean “one or more” of an element, where applicable, (i.e. unless in the context it would be obvious that only one of the element would be suitable). The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

It will also be noted that the use of the term “a” or “an” will be understood to denote “at least one” in all instances unless explicitly stated otherwise or unless it would be understood to be obvious that it must mean “one”. The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

It will be understood that any component defined herein as being included may be explicitly excluded from the claimed invention by way of proviso or negative limitation, such as any specific components or method steps, whether implicitly or explicitly defined herein.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Any reference to upper, lower, top, bottom or the like are intended to refer to a relative orientation of a particular element in relation to other elements and not necessarily in absolute terms, or to orientation during manufacture, shipping or use. The upper surface of an element, for example, can still be considered an upper surface in relation to another surface even when the element is lying on its side or upside down.

### Basic Coil Winding Pattern

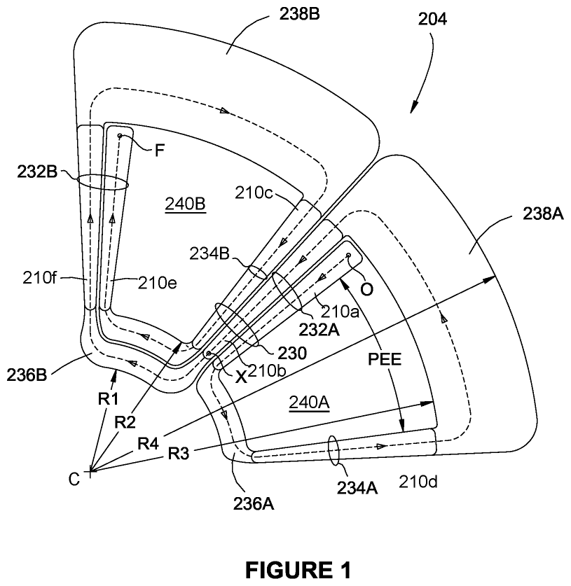

FIG. 1 shows a basic coil winding pattern 204 that forms part of a phase winding for a printed circuit board (PCB) stator. The basic winding pattern in the plan view of FIG. 1 has a shape substantially corresponding to a sector of a circle, with radii R1, R2, R3 and R4 extending from a center point C of the circle. The winding pattern 204 comprises a plurality of circumferentially distributed (i.e., spread out along a direction tangential to the radii of the circle), radially orientated traces or spokes 210a-210f, that are laid out between radii R2 and R3.

It will be seen in FIG. 1 that three immediately adjacent spokes 210a, 210b, 210c can be ganged together in a grouping 230 to enable the same direction of current flow and thus realize one stator pole. The winding pattern 204 can be formed by starting at an origin point O at a radial distance proximate to the length of radii R3 on one of the spokes 210a and interconnecting a set 232A of n=2 sequential spokes 210a and 210b with a set 234A of n-1=1 other sequential spoke(s) 210d disposed at a circumferential distance PEE (being the pole edge-to-edge distance) away from the set 232A utilizing inner circumferential trace(s) 236A and outer circumferential trace(s) 238A to intermediate point X at a radial distance from center point C proximate to the length of radii R2 on outer spoke 210b of spoke set 232A such that a coil 240A formed thereby is wound in a first winding direction. The coil pattern 204 continues from intermediate point X, encompassing a set 232B of n=2 sequential spokes 210e, 210f with a set 234B of n-1=1 additional other sequential spoke(s) 210c disposed at a circumferential distance PEE (being the pole edge-to-edge distance) away from the set 232B utilizing inner circumferential trace(s) 236B and outer circumferential trace(s) 238B to final point F at radial distance from center point C proximate to the length of distance R3 on an outermost spoke 210e of the spoke set 232B such that a coil 240B formed thereby is wound in a second winding direction, opposite the first winding direction. The winding pattern 204 can alternatively be described as commencing from point F and terminating at point O. It will be appreciated that winding pattern 204 forms the basis for a pair of alternating poles or ‘pole pair’.

The basic coil winding pattern 204 can be etched in one more copper foil layers of a PCB.

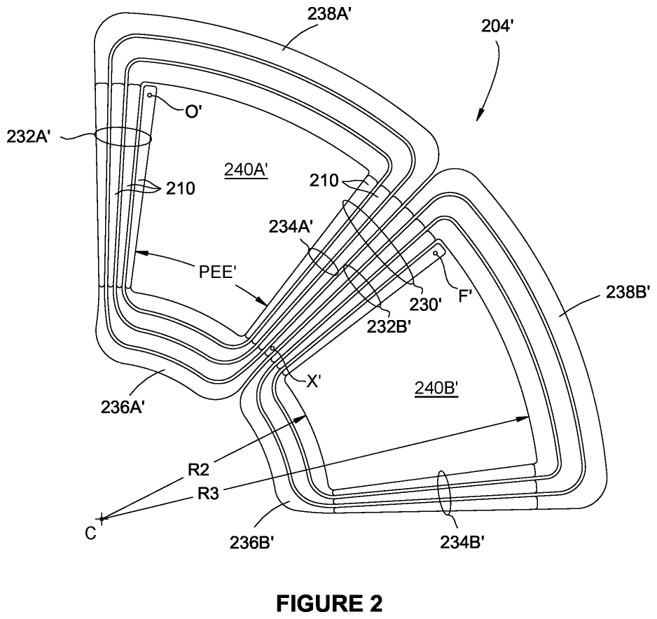

FIG. 2 shows a similar basic coil winding pattern 204′ where seven immediately adjacent spokes 210 are ganged together in a grouping 230′ to enable the same direction of current flow and thus realize a stator pole. As seen in FIG. 2, the winding pattern 204′ can be formed by starting at an origin point O′ at a radial distance from center point C proximate to the length of radii R3 on one of the spokes 210 and interconnecting a set 232A′ of n=4 sequential spokes 210 with a set 234A′ of n-1=3 other sequential spokes 210 disposed at a circumferential distance PEE′ (being the pole edge-to-edge distance) away from set 232A′ utilizing inner circumferential traces 236A′ and outer circumferential traces 238A′ to intermediate point X′ at a radial distance from center point C proximate to the length of radii R2 on an outer spoke of following n spoke set 232B′ such that a coil 240A′ formed thereby is wound in a first winding direction. The winding pattern 204′ continues from intermediate point X′, encompassing a set 232B′ of n=4 sequential spokes 210 with a set 234B′ of n-1=3 additional other sequential spoke(s) disposed at a circumferential distance PEE (being the pole edge-to-edge distance) away from set 232B′ utilizing inner circumferential traces 236B′ and outer circumferential traces 238B′ to final point F′ at a radial distance from center point C proximate to the length of radii R3 on an outermost spoke of the spoke set 232B′ such that a coil 240B′ formed thereby is wound in a second winding direction, opposite the first winding direction. The winding pattern 204′ can alternatively be described as commencing from point F′ and terminating at point O′. It will be appreciated that winding pattern 204′ forms the basis for a pole pair.

The basic coil winding pattern 204′ can be etched in one more copper foil layers of a PCB.

The basic coil winding patterns 204 or 204′ can be more generally described as a first coil comprised of a first set of n sequential circumferentially distributed and radially oriented spokes connected through inner and outer circumferential traces to a second set of n-1 sequential spokes disposed at a distance PEE, being the pole edge to edge circumferential distance, such that the first coil is wound in a first winding direction, coupled to a second adjacent coil comprised of a third set of n sequential spokes connected through inner and outer circumferential traces to a fourth set of n-1 sequential spokes disposed at a circumferential distance PEE, being the pole edge to edge distance, such that the second coil is wound in a second winding direction, opposite the first winding direction. Of course, the general pattern could alternatively be described in the reverse direction.

### Multi-Foil Layer PCB Stator

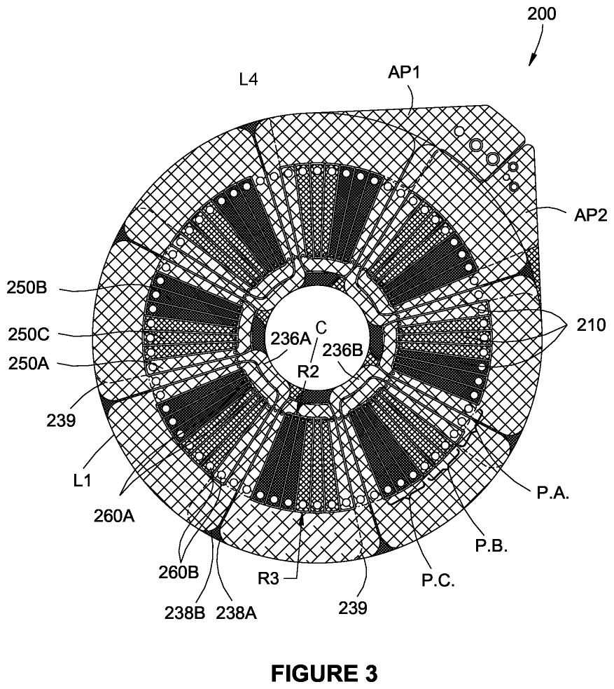

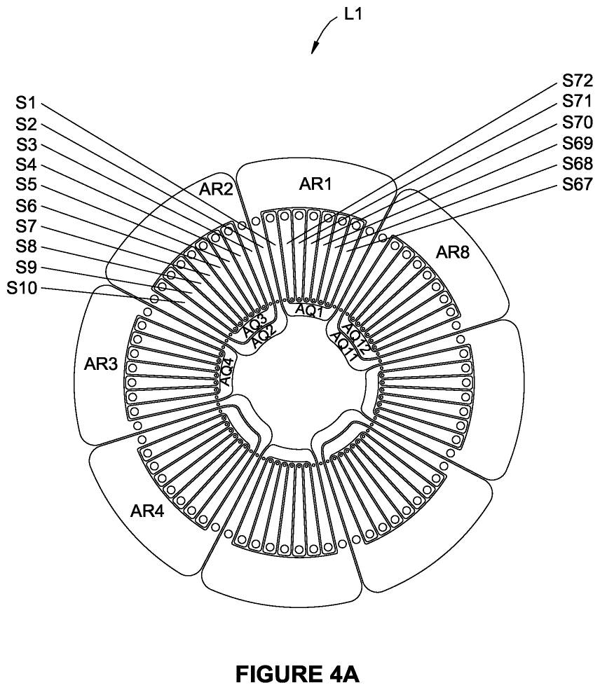

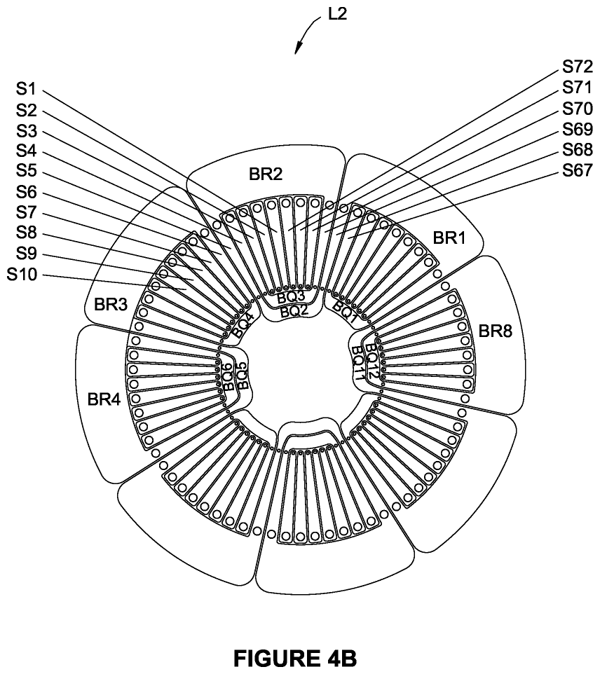

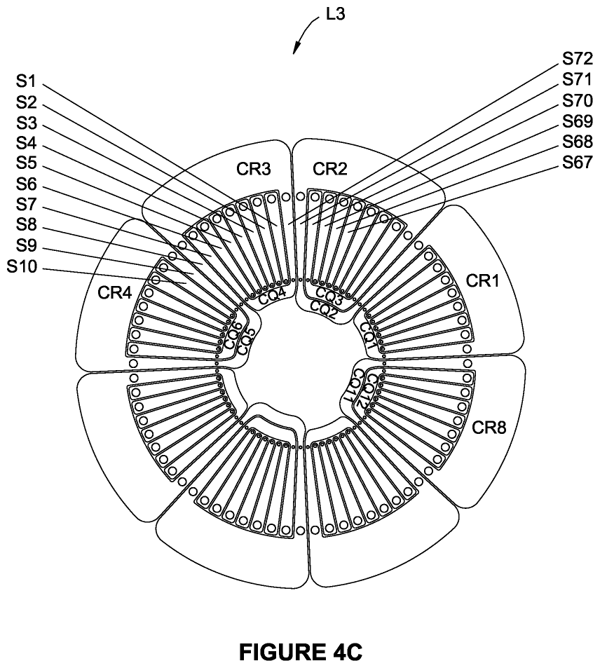

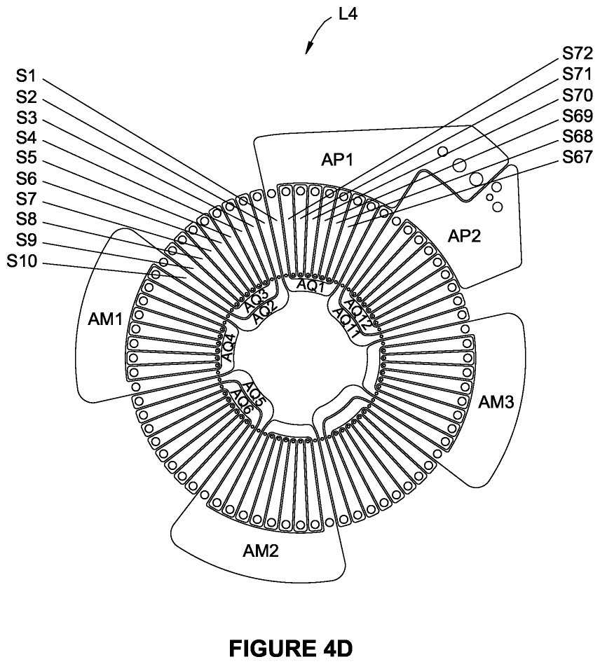

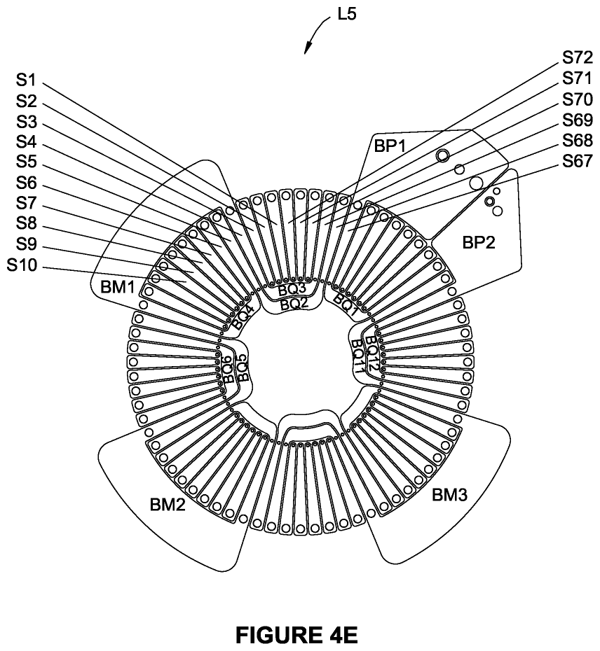

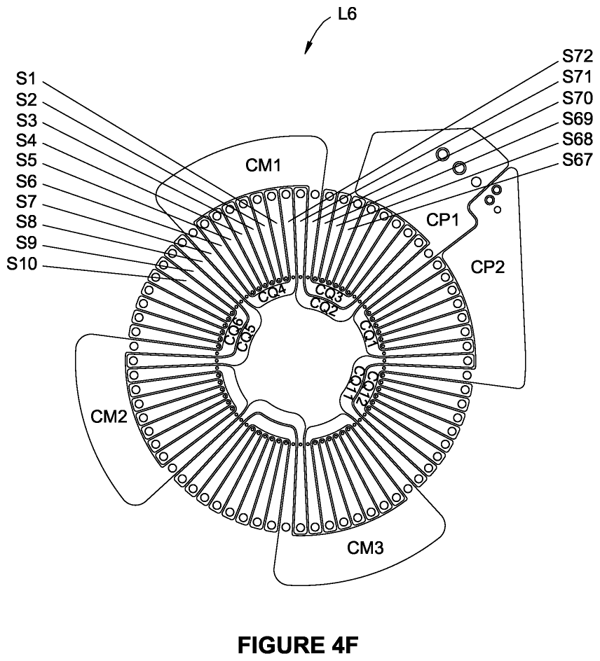

FIG. 3 is a plan view of a six-copper layer PCB stator 200. Each PCB copper layer (shown by layers L1 to L6 in FIGS. 4A to 4F) includes seventy-two spokes 210. In FIGS. 4A to 4F, the spokes 210 are denoted as S1 to S10 and the last six spokes 210 are denoted S67 to S72; the intervening spokes are not labelled for simplicity of illustration. The spokes 210 on the various PCB layers L1 to L6 are angularly aligned in an overlapping stacked relationship (i.e., spokes S1 of layers L1 to L6 are aligned to overlap each other; spokes S2 of layers L1 to L6 are aligned to overlap each other, and so forth) and, as discussed in greater detail below, are connected together in parallel. The spokes 210 are utilized in three phase winding patterns 250A, 250B and 250C, with phase winding pattern 250A being primarily visible in FIG. 3. (A different cross-hatching pattern is used to depict each phase.) In each phase winding pattern 250A, 250B, 250C, the basic coil winding pattern 204 of FIG. 1 is repeated four times to extend over three hundred and sixty degrees (mechanical) to form eight-poles, each pole utilizing three sequential spokes 210. The three phase winding patterns 250A, 250B and 250C are mechanically offset from each other by 30 degrees to provide 120 electrical degrees angular offset. The poles of each phase are labelled P.A., P.B., and P.C., respectively. The PCB stator 200 shown in FIG. 3 thus provisions a twenty-four-pole stator comprising three phases, eight poles per phase, where each pole utilizes three distinct sequential spokes 210. This stator can be mated to an eight-pole permanent magnet rotor.

As discussed in greater detail below, the inner and outer circumferential traces 236A, 236B, 238A, 238B employed in each phase winding pattern 250A, 250B, and 250C can be formed in one of the etched copper PCB layers L1 to L6, while another etched copper PCB layer can provide circumferential traces for interconnecting the pole pairs provisioned by sequences of basic coil winding pattern 204. For example, in FIG. 3, L1 is a top etched copper layer, shown in solid lines, and L4 is an internal copper layer, shown in stippled lines. The inner and outer circumferential traces 236A, 236B, 238A, 238B for the phase winding pattern 250A can be formed in the L1 layer (as seen also in FIG. 4A) and circumferential traces 239 (shown in stippled lines in FIG. 3) for interconnecting pole pairs can be formed in the L4 layer (see also FIG. 4D). Of course, placing these traces on the reverse layers is also possible.

FIGS. 4A-4F show the six individual etched copper layers L1-L6, respectively, of the PCB stator 200. In FIGS. 4A-4F:
each spoke 210 is individually enumerated as S1, S2 . . . S72
the inner circumferential traces 236A, 236B of basic coil winding pattern 204 are individually enumerated using an enumeration format of [symbol] Q [symbol] , where [symbol] represents the phase (A, B or C) and [symbol] is an individual reference in the sequence of 1, 2, . . . 12;
the outer circumferential traces 238A, 238B of basic coil winding pattern 204 are individually enumerated using an enumeration format of [symbol] R [symbol] , where [symbol] represents the phase (A, B or C) and [symbol] is an individual reference in the sequence of 1, 2, . . . 8; these are disposed on three layers of the PCB stator 200;
the circumferential traces 239 that are utilized to interconnect pole pairs are enumerated as [symbol] M [symbol] , where [symbol] represents the phase (A, B or C) and [symbol] is an individual reference from the set of {1 . . . 3}; these traces are disposed on three layers of the PCB stator 200;
lands AP1, AP2, BP1, BP2, CP1 and CP2 are intended as input/output (I/O) terminals, as discussed in greater detail below;
lands enumerated by “N” are intended as a neutral point, as discussed in greater detail below.

Each trace or land can be uniquely identified by the foil layer L1 to L6 on which it resides. For example, L1:S1 refers to spoke #1 on PCB layer L1.

The interconnections of the various traces shown in FIGS. 4A-4F in and between PCB layers are described below in a shorthand script using operators “→” and “∥”, where:
“→” represents a serial connection between traces; in some instances these interconnections are seamless on the same layer and in other instances these interconnections arise from the fact that the spokes are all connected in parallel and inner or outer circumferential traces are connected to the spokes in various layers;
“∥” represents a parallel connection between traces, it being understood that in the shorthand script below parallel connections take precedence over serial connections.

The trace interconnections to provision phase winding pattern 250A in respect of the first electrical phase A can thus be described as L4:AP1→L1:S1∥L2:S1∥ . . . ∥L6:S1→L1:AQ1∥L4:AQ1→L1:S66∥L2:S66∥ . . . ∥L6:S66→L1:AR1→L1:S2∥L2:S2∥ . . . ∥L6:S2→L1:AQ2∥L4:AQ2→L1:S11∥L2:S11∥ . . . ∥L6:S11→L1:AR2→L1:S3∥L2:S3∥ . . . ∥L6:S3→L1:AQ3∥L4:AQ3→L1:S10∥L2:S10∥ . . . ∥L6:S10→L4:AM1→L1:S19∥L2:S19∥ . . . ∥L6:S19→L1:AQ4∥L4:AQ4→ . . . →L1:AQ12∥L4:AQ12→L1:S64∥L2:S64∥ . . . ∥L6:S64→L4:AP2

Likewise, the trace interconnections to provision phase winding pattern 250B in respect of the second electrical phase B can thus be described as: L5:BP1→L1:S67∥L2:S67∥ . . . ∥L6:S67→L2:BQ1∥L5:BQ1→L1:S60∥L2:S60∥ . . . ∥L6:S60→L2:BR1→L1:S68∥L2:S68∥ . . . ∥L6:S68→L2:BQ2∥L5:BQ2→L1:S5∥L2:S5∥ . . . ∥L6:S5→L2:BR2→L1:S69∥L2:S69∥ . . . ∥L6:S69→L2:BQ3∥L5:BQ3→L1:S4∥L2:S4∥ . . . ∥L6:S4→L5:BM1→L1:S13∥L2:S13∥ . . . ∥L6:S13→L2:BQ4∥L5:BQ4→ . . . →L2:BQ12∥L5:BQ12→L1:S58∥L2:S58∥ . . . ∥L6:S58→L5:BP2

The trace interconnections to provision phase winding pattern 250C in respect of the third electrical phase C follow a similar pattern commencing at input/output CP1 and spoke S61, utilizing layers L3 and L6, terminating at terminal land L6:CP2.

The placement of the traces and lands on the various PCB layers L1 L6 is one of convenience. The traces and lands on each PCB layer can alternatively be placed on alternative layers. For example, the traces and lands placed on layer L1 can be placed on layer L6 and vice-versa.

As discussed previously, the spokes 210 on each of the etched copper PCB layers L1-L6 are aligned in an overlapping stacked relationship and electrically interconnected with one another; for example, the S1 spokes on each of layers L1 L6 are interconnected to form parallel electrical paths. These interconnections can be formed by arrays of inner and outer vias 260A and 260B at radial distances from center point C proximate to the length of radii R2 and R3, respectively, as seen in FIG. 3. These vias 260A, 260B are straight vias, not blind or buried, and thus may be drilled and plated to extend through the PCB layers L1-L6 at one time.

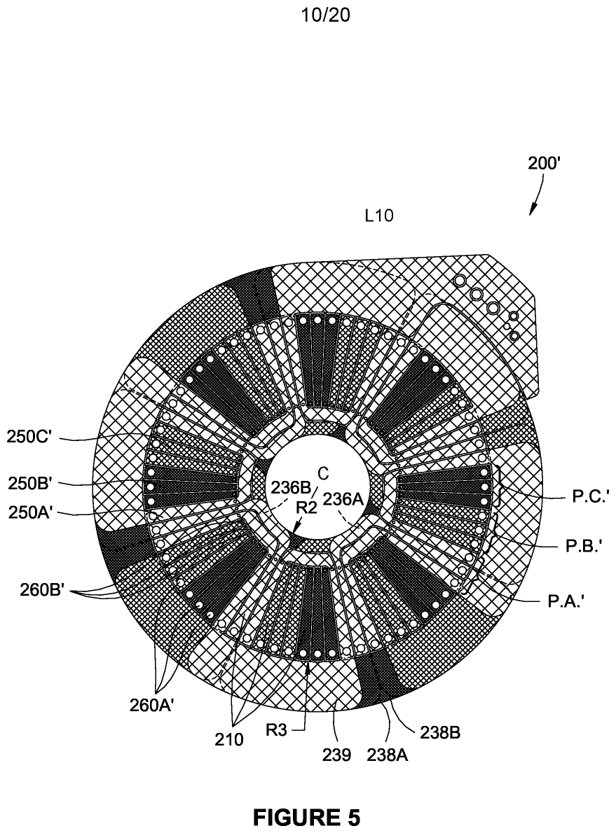

Thus, PCB stator 200 may be formed by, in sequence: (i) provisioning three double-sided PCB panels, each panel having top and bottom copper foils; (ii) etching each of the PCB copper foil layers; (iii) laminating/bonding the three PCB panels together with 2 layers of “pre-preg” (i.e. a composite material made from pre-impregnated fibers and a partially cured polymer matrix), as known in the art; and (iv) drilling and plating the straight vias 260A, 260B. Alternatively, six single-foil layer PCB panels can be employed and the process could include etching each foil layer, laminating the six PCB panels together with 5 layers of “pre-preg”, then drilling and plating to establish the straight vias 260A. 260B. The stippled lines in FIG. 5 show the outlines of layer L10.

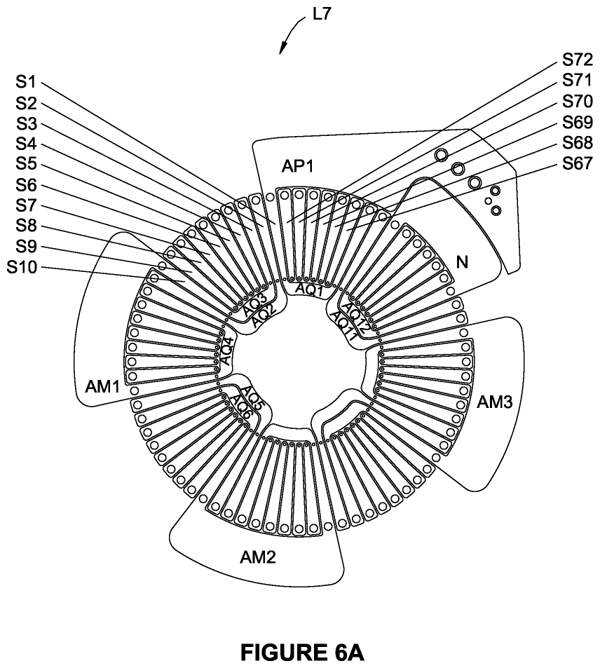

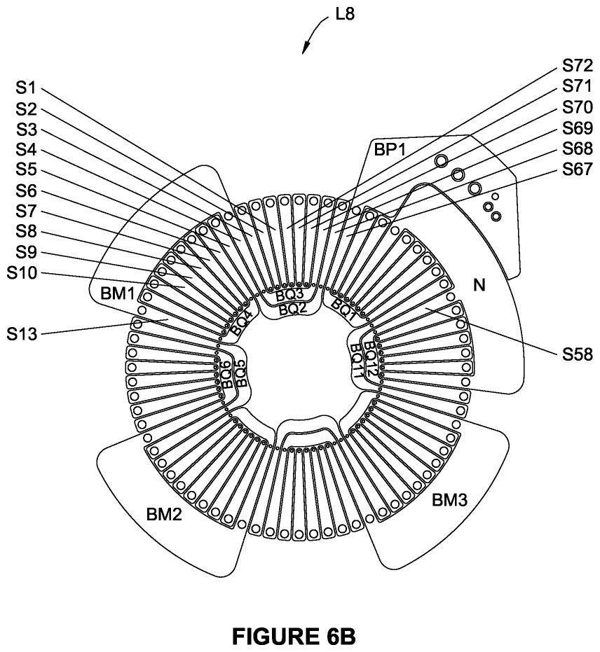

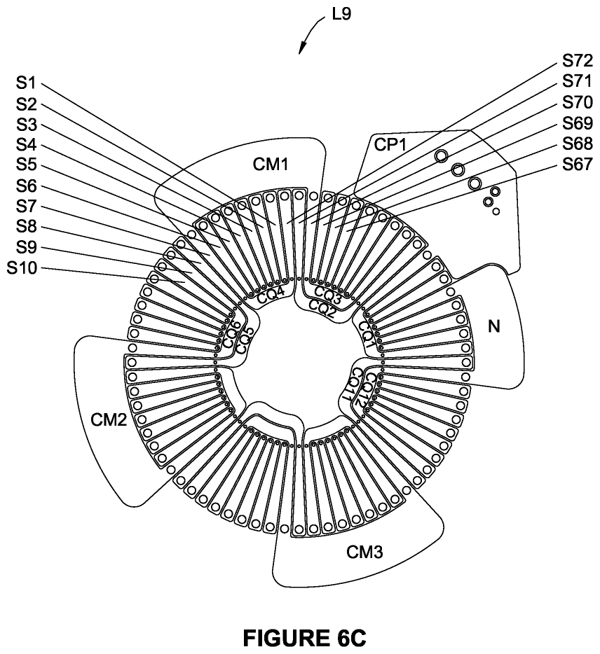

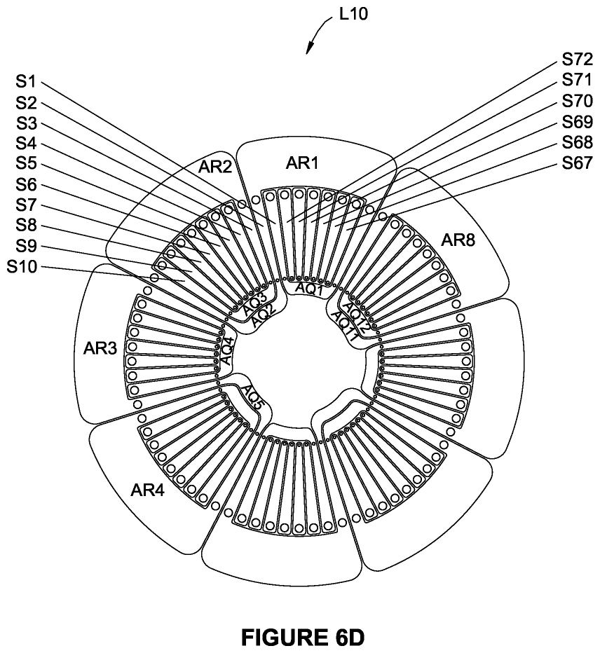

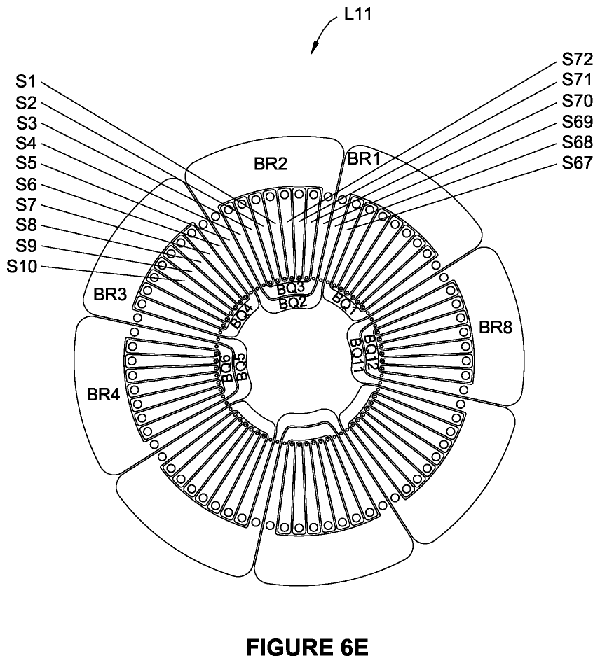

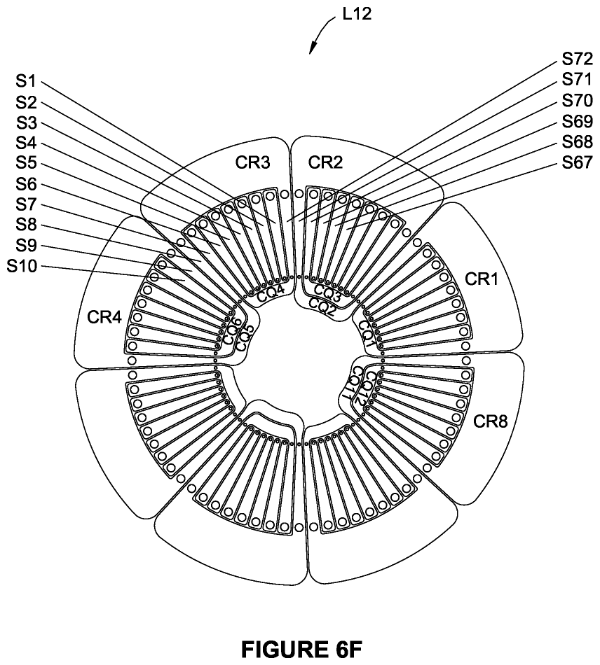

FIG. 5 is a plan view of a six-layer PCB stator 200′, substantially similar to PCB stator 200, featuring winding patterns 250A′, 250B′, and 250C′, each of which is disposed on two of the six PCB layers, which collectively provision a twenty-four-pole stator comprising three phases, eight poles per phase. FIGS. 6A-6F show the traces in six individual layers, labeled L7-L12, of the PCB stator 200′.

Utilizing the labelling nomenclature and interconnection shorthand discussed previously, the trace interconnections to provision phase winding pattern 250A′ in respect of a first electrical phase can be described as: L7:AP1→L7:S1∥L8:S1∥ . . . ∥L12:S1→L7:AQ1∥L10:AQ1→L7:S66∥L8:S66∥ . . . ∥L12:S66→L10:AR1→L7:S2∥L8:S2∥ . . . ∥L12:S2→L7:AQ2∥L10:AQ2→L7:S11∥L8:S11∥ . . . ∥L12:S11→L10:AR2→L7:S3∥L8:S3∥ . . . ∥L12:S3→L7:AQ3∥L10:AQ3→L7:S10∥L8:S10∥ . . . ∥L12:S10→L7:AM1→L7:S19∥L8:S19∥ . . . ∥L12:S19→L7:AQ4∥L10:AQ4→L7:AQ12∥L10:AQ12→L7:S64∥L8:S64∥ . . . ∥ . . . ∥L12:S64→L7:N∥L8:N∥L9:N

The trace interconnections to provision phase winding pattern 250B′ in respect of a second electrical phase can be described as: L8:BP1→L7:S67∥L8:S67∥ . . . ∥L12:S67→L8:BQ1∥L11:BQ1→L7:S60∥L8:S60∥ . . . ∥L12:S60→L11:BR1→L7:S68∥L8:S68∥ . . . ∥L12:S68→L8:BQ2∥L11:BQ2→L7:S5∥L8:S5∥ . . . ∥L12:S5→L11:BR2→L7:S69∥L8:S69∥ . . . ∥L12:S69→L8:BQ3∥L11:BQ3→L7:S4∥L8:S4∥ . . . ∥L12:S4→L8:BM1→L7:S13∥L8:S13∥ . . . ∥L12:S13→L8:BQ4∥L11:BQ4→L8:BQ12∥L11:BQ12→L7:S58∥L8:S58∥ . . . ∥L12:S58→L7:N∥L8:N∥L9:N

The trace interconnections to provision phase winding pattern 250C′ in respect of a third electrical phase follow a similar pattern commencing at input/output CP1 and spoke S61, utilizing layers L9 and L12, and terminating at common point L7:N∥L8:N∥L9:N.

The placement of the traces and lands on the various PCB layers L7 L12 is one of convenience. The traces and lands on each PCB layer can alternatively be placed on alternative layers. For example, the traces and/or lands placed on layer L7 can be placed on layer L12 and vice-versa.

From the foregoing, it will be seen that the spokes 210 on each of the PCB layers-7-L12 are aligned in an overlapping stacked relationship and interconnected with one another; for example, the S1 spokes on each of layers L7 L12 are interconnected to form parallel electrical paths. These interconnections can be formed by circular arrays of inner and outer vias 260A′ and 260B′ at distances from center point C proximate to the lengths of radii R2 and R3, respectively, as seen in FIG. 5. These vias 260A′, 260B′ are straight vias, not blind or buried, and thus may be drilled and plated to extend through the PCB layers L7-L12 at one time. PCB stator 200′ may be formed in the same or similar manner to that of PCB stator 200, as previously discussed.

### Stacked PCB Stator

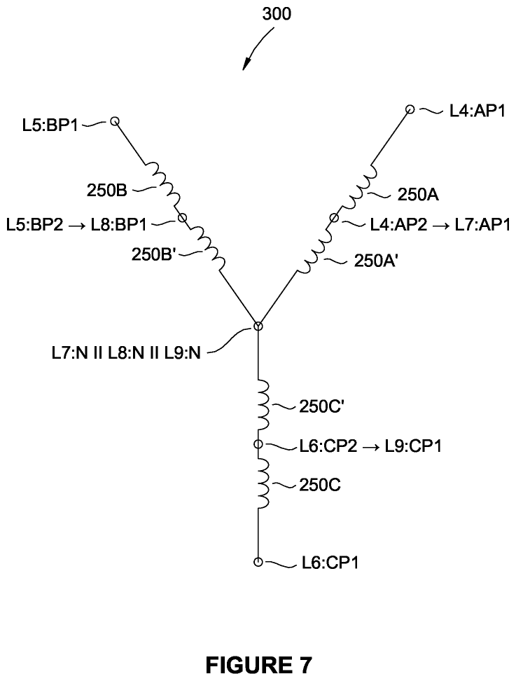

The two PCB stators 200 and 200′ may be ganged together in a manner in which corresponding phase windings 250A and 250A′, 250B and 250B′, 250C and 250C′ (which, given the context, may be referred to herein as “phase winding segments”) are joined in a series connection, with the various electrical phases being connected together in a star or “Y” arrangement, as seen in the circuit diagram of FIG. 7, to yield a combined or stacked PCB stator 300. This can be accomplished by physically aligning the two PCB stators 200 and 200′ together (so that the spokes 210 of each PCB stator are in overlapping stacked relationship), laminating together the PCB stators 200 and 200′, and then drilling and plating straight vias extending through the PCB stators 200 and 200′ to enable input/output terminals and serial connections.

More particularly, with additional reference to the foregoing FIGS. 4A-4F and 6A-6F, it will be seen that:
lands L4:AP1, L5:BP1 and L6:CP1 can provision stator input/output terminals;
lands L4:AP2, L5:BP2 and L6:CP2 can be electrically coupled to lands L7:AP1, L8:AP1 and L9:CP1, respectively, so as to provision intermediate terminals for serial connections of phase segments 250A to 250A′, 250B to 250B′, and 250C to 250C′, respectively;
Lands L7:N∥L8:N∥L9:N Provision Common Neutral Point.

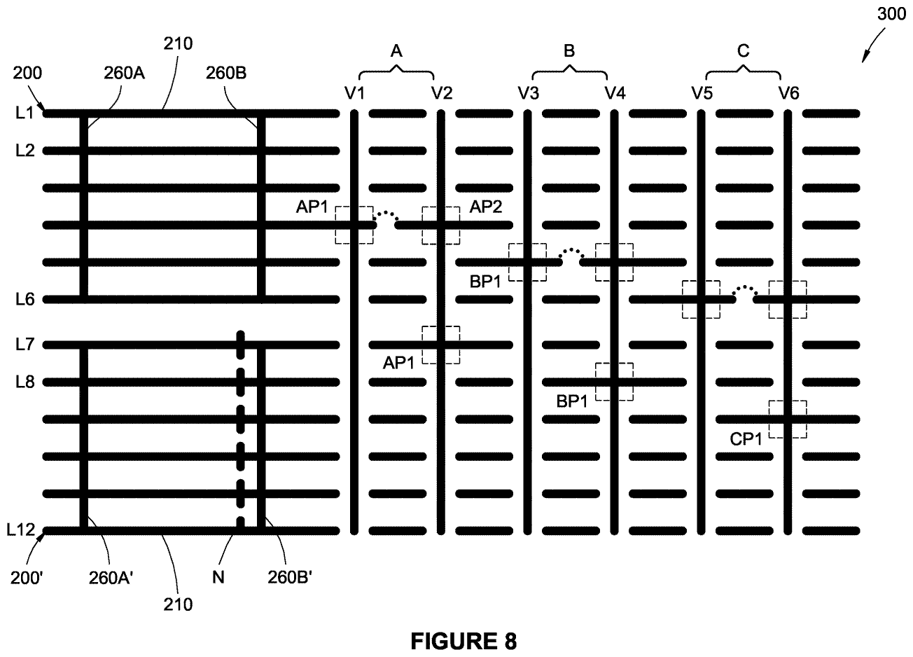

FIG. 8 is a schematic cross-sectional-like representation, not precise or to scale, of the combined or stacked PCB stator 300 illustrating how an array of straight terminal vias V1-V6 can be drilled and plated to extend through PCB stators and 200′ after laminating PCB stators 200 and 200′ together to provide the foregoing interconnections for serially connecting the phase winding segments as well as provisioning I/O terminals for the stacked PCB 300.

Two terminal vias are required per phase:
Via V1 intersects and is electrically connected to land L4:AP1. Via V2 intersects and is electrically connected to land L4:AP2 as well as intersecting and electrically connecting land L7:AP1. Accordingly, current can be conducted from land/terminal L4:AP1 through the phase winding 250A to land/terminal L4:AP2 and land/terminal L7:AP1, and then through the phase winding 250A′ to neutral point N (represented schematically in stippled line);
Via V3 intersects and is electrically connected to land L5:BP1. Via V4 intersects and is electrically connected to land L5:BP2 as well as intersecting and electrically connecting land L8:BP1. Accordingly, current can be conducted from land/terminal L5:BP1 through the phase winding 250B to land/terminal L5:BP2 and land/terminal L8:BP1, and then through the phase winding 250B′ to neutral point N (represented schematically in stippled line);
Via V5 intersects and is electrically connected to land L6:CP1. Via V6 intersects and is electrically connected to land L6:CP2 as well as intersecting and electrically connecting land L9:CP1. Accordingly, current can be conducted from land/terminal L6:CP1 through the phase winding 250C to land/terminal L6:CP2 and land/terminal L9:CP1, and then through the phase winding 250C′ to neutral point N (represented schematically in stippled line).

Coupling the corresponding phase winding segments of the PCB stators 200 and 200′ in a serial manner may, for a given power rating, provide advantages for the motor system as opposed, for example, to a twelve-layer PCB with a single winding per phase, despite the fact that the ohmic resistance of the serially connected PCB stators is four times the twelve-layer PCB board. The primary advantage is that the injected current can be lowered in half and more back-EMF voltage is produced. The lower current can result in lower switching losses in the inverter, and the longer conduction length can increase inductance in comparison with the twelve-layer PCB board which, in stators with no back iron, is an important parameter as an inductance-less stator is typically characterized by large torque ripple, noise, vibration and electromagnetic interference (EMI) issues. An increased inductance can enable more smoothing current through the motor.

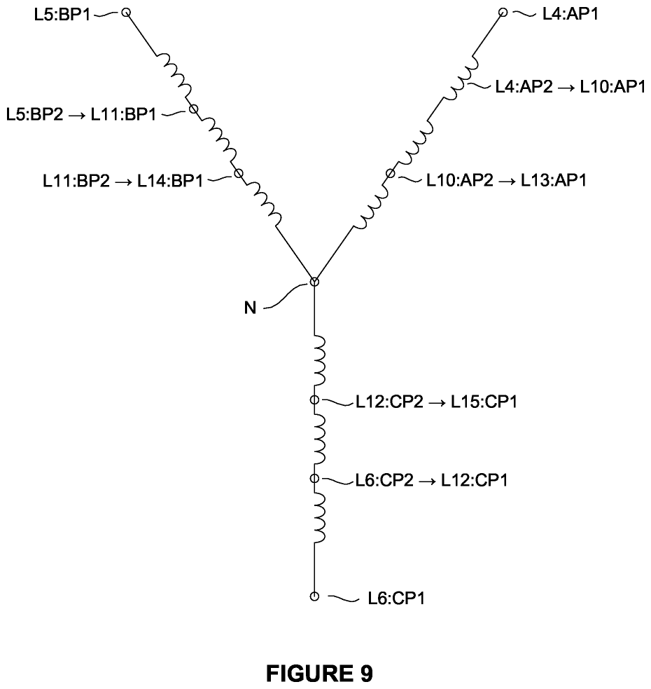

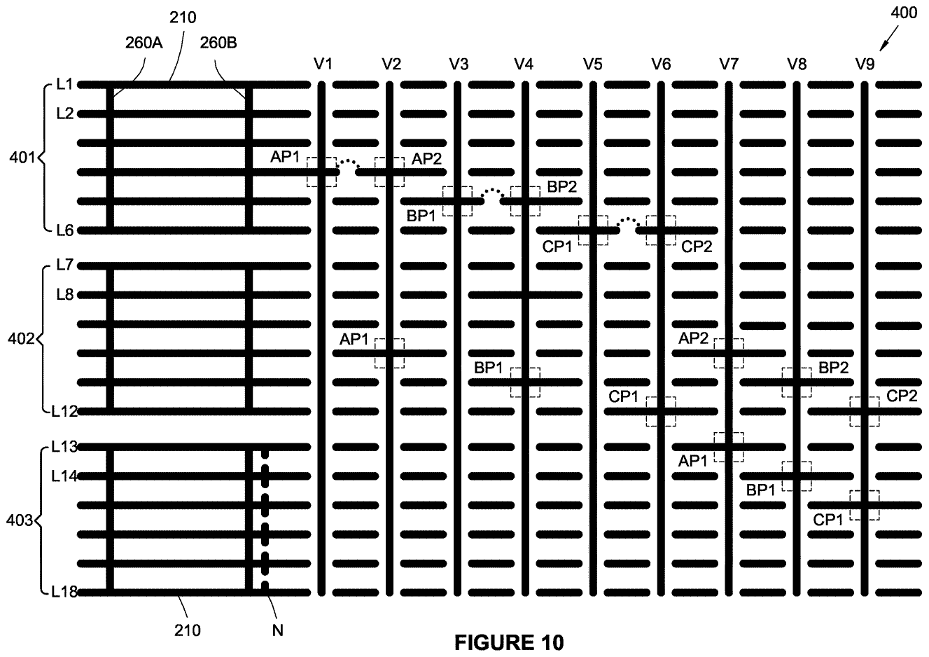

It should be appreciated that more than two six-layer PCBs can be laminated together to provision a stacked PCB stator with more than two serially connected phase winding segments per phase. For example, the circuit diagram of FIG. 9 shows a three-phase stacked PCB stator 400 with three serially connected phase winding segments per phase; the three electrical phases being connected together in a star or “Y” arrangement. FIG. 10 is a schematic cross-sectional-like representation, not precise or to scale, of stacked PCB stator 400 illustrating how a series of straight vias V1-V9 can be drilled and plated after laminating three six-layer PCB stators 401, 402, and 403 together so as to extend through the PCB stators 401, 402, and 403 and to provide interconnections for serially connecting three phase winding segments, per phase. The stacked PCB stator 400 may be manufactured in a manner similar to stacked PCB 300 in that the three six-panel PCB stators 401, 402 and 403 are first laminated together and then the straight terminal vias V1-V9 can be drilled and plated.

PCB 401 comprises six copper foil layers L1-L6, PCB 402 comprises six copper foil layers L6-L12. and PCB 403 comprises six copper foil layers L13-L18. PCBs 401 and 402 are substantially similar to PCB 200 and PCB 403 is substantially similar to PCB 200′. It will be noted that one additional terminal via is required per phase, as compared to stacked PCB 300 shown in FIG. 8, such that three terminal vias are required per phase:
Via V1 intersects and is electrically connected to land L4:AP1. Via V2 intersects and is electrically connected to land L4:AP2 as well as intersecting and electrically connecting land L10:AP1. Via V7 intersects and is electrically connected to land L10:AP2 as well as intersecting and electrically connecting land L13:AP1. Accordingly, current can be conducted from land/terminal L4:AP1 through the ‘A’ phase winding segment embedded in PCB panel 401 to land/terminal L4:AP2 and land/terminal L10:AP1, and then through the ‘A’ phase winding segment embedded in PCB panel 401 to land/terminal L10:AP2 and land/terminal L13:AP1, then through the ‘A’ phase winding segment embedded in PCB panel 403 to neutral point N (represented schematically in stippled line);
Via V3 intersects and is electrically connected to land L5:BP1. Via V4 intersects and is electrically connected to land L5:AP2 as well as intersecting and electrically connecting land L11:BP1. Via V8 intersects and is electrically connected to land L11:BP2 as well as intersecting and electrically connecting land L14:BP1. Accordingly, current can be conducted from land/terminal L5:BP1 through the ‘B’ phase winding segment embedded in PCB panel 401 to land/terminal L5:BP2 and land/terminal L11:BP1, and then through the ‘B’ phase winding segment embedded in PCB panel 401 to land/terminal L11:BP2 and land/terminal L14:BP1, then through the ‘B’ phase winding segment embedded in PCB panel 403 to neutral point N (represented schematically in stippled line);
Via V5 intersects and is electrically connected to land L6:CP1. Via V6 intersects and is electrically connected to land L6:CP2 as well as intersecting and electrically connecting land L12:CP1. Via V9 intersects and is electrically connected to land L12:CP2 as well as intersecting and electrically connecting land L15:CP1. Accordingly, current can be conducted from land/terminal L6:CP1 through the ‘C’ phase winding segment embedded in PCB panel 401 to land/terminal L6:CP2 and land/terminal L12:CP1, and then through the ‘C’ phase winding segment embedded in PCB panel 401 to land/terminal L12:CP2 and land/terminal L15:CP1, then through the ‘C’ phase winding segment embedded in PCB panel 403 to neutral point N (represented schematically in stippled line).

Utilizing basic coil winding pattern 204, it will be appreciated that a class of stacked PCB stators can be defined, and constructed, by laminating a plurality of PCB stators together and serially connecting the corresponding phase winding segments of the ganged PCB stators with straight terminal vias.

Let NS be the number of spokes; NP be the number of phases; PPP be the number of poles per phase, and NSP the number of spokes per pole. Then:

NS=NSP*PPP*NP, subject to the constraints that
NSP is an odd number>1, and
PPP is an even number.

The number of PCB stators, NB, required is equal to the number of serial phase winding segments desired; and the number of copper foil layers per PCB stator is 2*NP. The number of straight terminal vias, NV, required to be drilled and plated after laminating together the NB quantity of PCT stators is NP*NB.

In the present disclosure, in any instance where a plurality of conductive layers is described, it will be noted that it may be a plurality of foil layers, or alternatively, it have any other suitable structure other than a foil structure.

Although specific constructions and advantages of the illustrated embodiment(s) have been enumerated above, persons skilled in the art will appreciate that there are yet more alternative implementations and modifications possible, and that the above examples are only illustrations of one or more implementations which may include some, none, or all of the enumerated advantages. The scope, therefore, is to be limited only by the appended claims.

1. A stator, comprising:
a first PCB stator comprising a plurality of first conductive layers, the first PCB stator including a circumferentially distributed sequence of radially-orientated first spokes, each first spoke being formed from overlapping radially orientated first traces in the first conductive layers, wherein the overlapping traces are interconnected via at least two straight first vias at opposing ends of the radially orientated first traces, wherein the first spokes are connected in a basic coil winding pattern to form a first set of one or more phase winding segments;
a second PCB stator comprising a plurality of second conductive layers, the second PCB stator including a circumferentially distributed sequence of radially-orientated second spokes, each second spoke being formed from overlapping radially orientated second traces in the second conductive layers, wherein the overlapping second traces are interconnected via at least two straight second vias at opposing ends of the radially orientated second traces, wherein the second spokes are connected in said basic coil winding pattern to form a second set of one or more phase winding segments;
wherein the first and second PCB stators are laminated together and a series of straight vias extend through the first and second PCB stators to provision input/output terminals and to serially connect the first set of phase winding segments to corresponding phases of the second set of phase winding segments.

2. The stator according to claim 1, wherein said basic coil winding pattern comprises a first coil formed of a first set of n sequential spokes of the first spokes connected through first inner and outer circumferential traces to a second set of n-1 sequential spokes of the first spokes disposed at a pole edge to edge circumferential distance from the first set of n sequential spokes such that the first coil is wound in a first winding direction, coupled to a second adjacent coil formed of a third set of n sequential spokes of the first spokes connected through second inner and outer circumferential traces to a fourth set of n-1 sequential spokes of the first spokes disposed at the pole edge to edge circumferential distance from the third set of n sequential spokes such that the second coil is wound in a second winding direction, opposite the first winding direction.

3. The stator according to claim 1, wherein the stator has three electrical phases that are connected together at a common point to provision a ‘Y’ connection.

4. The stator according to claim 1, wherein the plurality of first conductive layers is a plurality of first foil layers and the plurality of first conductive layers is a plurality of first foil layers.

5. A stacked PCB stator, comprising:
a plurality, NB, of PCB stators each comprising a plurality, NF, of conductive layers, each of the NB PCB stators including a circumferentially distributed sequence of NS radially-orientated spokes, each spoke being formed from overlapping radially orientated traces in the conductive layers, wherein the overlapping traces are interconnected via at least two straight vias at opposing ends of the radially orientated traces, wherein the NS spokes are connected in a basic coil winding pattern to form NB sets of NP phase winding segments, where
NB>1,
NP is a number of electrical phases,
NF=2*NP, NF being the number of conductive layers of each PCB stator, and
NS=NSP*PPP*NP, subject to the constraints that NSP is an odd number>1 and PPP is an even number, where NSP is a number of spokes per pole, and PPP is a number of poles per phase;
wherein the NB PCB stators are laminated together and a series of NV straight vias that extend through the NB PCB stators to provision input/output terminals and to serially connect corresponding phases of the NB sets of phase winding segments, where NV=NP*NB.

6. The stacked PCB stator according to claim 5, wherein said basic coil winding pattern comprises a first coil formed of a first set of n sequential spokes of the spokes connected through first inner and outer circumferential traces to a second set of n-1 sequential spokes of the spokes disposed at a pole edge to edge circumferential distance from the first set of n sequential spokes such that the first coil is wound in a first winding direction, coupled to a second adjacent coil formed of a third set of n sequential spokes of the spokes connected through second inner and outer circumferential traces to a fourth set of n-1 sequential spokes of the spokes disposed at the pole edge to edge circumferential distance from the third set of n sequential spokes such that the second coil is wound in a second winding direction, opposite the first winding direction.

7. The stacked PCB stator according to claim 5, wherein the stacked PCB stator has three electrical phases that are connected together at a common point to provision a ‘Y’ connection.

8. The stator according claim 5, wherein the plurality of first conductive layers is a plurality of first foil layers and the plurality of first conductive layers is a plurality of first foil layers.

9. The stator according to claim 2, wherein the stator has three electrical phases that are connected together at a common point to provision a ‘Y’ connection.

10. The stator according to claim 2, wherein the plurality of first conductive layers is a plurality of first foil layers and the plurality of first conductive layers is a plurality of first foil layers.

11. The stator according to claim 3, wherein the plurality of first conductive layers is a plurality of first foil layers and the plurality of first conductive layers is a plurality of first foil layers.

12. The stacked PCB stator according to claim 6, wherein the stacked PCB stator has three electrical phases that are connected together at a common point to provision a ‘Y’ connection.

13. The stator according to claim 6, wherein the plurality of first conductive layers is a plurality of first foil layers and the plurality of first conductive layers is a plurality of first foil layers.

14. The stator according to claim 7, wherein the plurality of first conductive layers is a plurality of first foil layers and the plurality of first conductive layers is a plurality of first foil layers.
